(19) United States
(12) Patent Application Publication
(10) Pub. No.: US 2008/0005350 A1
(43) Pub. Date: Jan. 3, 2008

(54) System and method for synchronized content rendering in a multi-node network

(76) Inventor: Oleg Logvinov, East Brunswick, NJ (US)

Correspondence Address: MINTZ LEVIN COHN FERRIS GLOVSKY & POPEO, 666 THIRD AVENUE, NEW YORK, NY, 10017, US

(21) Appl. No.: 11/810,460

(22) Filed: Jun. 5, 2007

Related U.S. Application Data
(60) Provisional application No. 60/811,177, filed on Jun. 5, 2006.

(51) Int. Cl. G06F 15/16

(52) U.S. Cl. 709/231; 709/248

(57) ABSTRACT

The trend toward moving to digital content is progressing and expanding every day. With that trend comes the availability of a multitude of content from many content sources. There is a need for this content to be distributed to multiple destinations, and there is a further need to have the content synchronized among those multiple destinations. Embodiments described herein detail a method of synchronizing this content in an asynchronous environment, such as a powerline network.

This application claims priority to U.S. Provisional Patent Application No. 60/811,177, filed Jun. 5, 2006, which is hereby incorporated by reference herein in its entirety.

### BACKGROUND OF THE INVENTION

1. Field of the Invention

Embodiments of this invention relates generally to the distribution and playback synchronization of content, such as audio, video or other data, over conventional mediums, such as cable, DSL, wireless, or powerline (electric power conveying media used also as a local communications network media), and more particularly, to utilizing one or a combination of these networks to create a content distribution system that may be synchronized based on user response and interaction resulting from the content rendering. Embodiments of the invention have uses on any network or combination of networks used for content distribution.

2. Background of the Invention

Multimedia distribution is experiencing a shift from old-fashioned analog signals into a digital distribution. In the recently released report titled “Media Networking 2005: The Networked Living Room Becomes a Reality”, InStat cites the following important trend. Total media networking connections in homes will grow from over 50 million in 2005 to over 200 million in 2009, a 29% compound annual growth rate. This shift creates a demand for new products, and new products demand new types of semiconductors that incorporate digital technologies supporting such functions as communications and media rendering.

These statements all point to a continuing shift to digital content. More specifically, these trends also point to the growing need for, and continuing proliferation of, digital content sources, digital content distribution networks and mediums, and digital content rendering devices such as digital music players, smart phones, or other Internet appliances. With the basic concept of content distribution in place, embodiments of this invention detail a method and system whereby content can be rendered in a synchronized manner. When content is distributed to multiple destinations, or when different sources, or types of content, (such as audio and video) are distributed to a destination, there is a need to keep the content synchronized. For example, if audio content is distributed to multiple rooms, the streams need to be in sync to ensure a good listener experience, or a video and audio stream going to the same destination needs to be in sync for the proper output to be seen and heard (lip-sync). Therefore there exists a need to have a method and system that allows for synchronized content rendering in a multi-node powerline environment.

### SUMMARY OF EMBODIMENTS OF THE INVENTION

Embodiments of this invention relate to a content distribution network for homes, businesses, apartment complexes, and other residential buildings, where streaming audio and multimedia content is sourced/originated, captured, stored, transmitted, received, and rendered through a number of devices located throughout the network. Embodiments of the invention are described for operation on an electrical power distribution network; however, these concepts and methods can be applied to any network, wired or wireless, or a combination of networks where one of these networks may be a powerline network. Embodiments of this invention detail a method of synchronizing audio, and other digital content, in an asynchronous network, such as a powerline network. The preferred embodiment described here relates to a local area or wide area broadband power line network, wherein there are multiple nodes that have the ability to source, distribute, or render the multimedia content. The major benefits of embodiments of the invention are to provide precise time synchronization among ALL content rendering nodes on the network, and provide the ability to use long buffers on the receiver side of the network nodes.

### BRIEF DESCRIPTION OF THE DRAWING

Embodiments of the present invention will be subsequently described further with reference to the accompanying diagram in which:

FIG. 1 shows a diagram of the functional blocks of a networked communications device that has synchronization functionality added.

100 Network and network interface

105 PHY or Physical Layer which connects the apparatus to the network

107 Data recovered from the network

108 Timing information recovered from the Data

109 External timing sync signal

110 Control signals that control the buffer and lookup table logic

115 Lookup table and compare logic

120 Buffer, which is digital memory

125 Rendering engine that converts digital content data to analog output

130 Analog content output such as audio or video

200 The apparatus that contains the synchronization functionality

### DETAILED DESCRIPTION OF EMBODIMENTS OF THE INVENTION

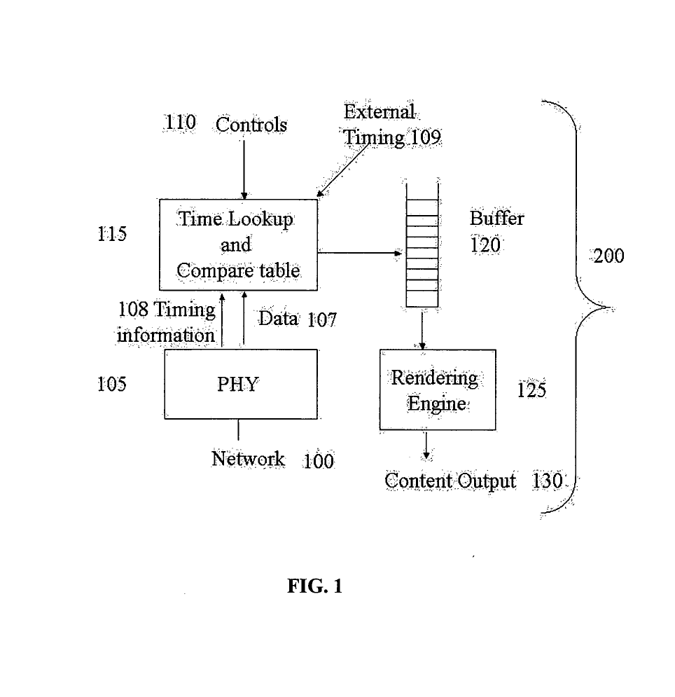

FIG. 1 illustrates a block diagram of the inventive features of a powerline communications device that allows for precise synchronization of content rendering of multiple network rendering nodes.

Data 107 is received from the content distribution network 100, through the PHY 105, which is the “PHYsical layer” interface between the network 100 and the apparatus 200. In this scenario, assume that the data stream is an audio stream coming from a source apparatus over the network, and that all of the digital content packets are individually tagged with timing reference data, and a time flag is generated by the PHY 105 and is derived from the Orthogonal Frequency Division Multiplexing (OFDM) synchronization signal.

When received, the data is detected, decoded and the embedded timing information is extracted to create a timing signal 108. The data also contains meta data such as a sequence number, stream ID. The content data 107 is loaded into the receive Buffer 120. The timing information 108 is recorded in the look up table, and the location of the data 107, representing a time slice of the analog content (in digital form) in the buffer 120, are associated with each other in the table. This table provides a key flexibility to shift, group and manage the data better than any “sync-signal-only” system can provide.

A macro synchronization signal is then used to tell the apparatus which time stamped data 107 in the Buffer 120 to render. Since all rendering devices in the network have access to the synchronization signal, all devices can synchronize their playback rendering providing a result that the eye or ear cannot detect.

In order to maintain synchronization between the rendering apparatus, it is sometimes necessary to adjust system parameters. For example, the bit depth of the buffer can be reduced and the rendering engine adjusted to use fewer bits. This allows the necessary data to arrive if the data rate is slowing down. In an embodiment, this invention to allow the buffer to skip data in order to catch up to the macro clock. In this case, time slices represented by groups of sequential data are skipped. For example, MPEG data group 188 bytes at a time. It is important that the data be grouped in such a way that adding or removing it doesn't affect the rendering engine. Interpolation of the data, such as done in cellular codex devices, can also help minimize the noise that could result. It is also possible to add data to the rendering engine input so as to cause it to “march in place” until the synchronization clock catches up. If a slice of data is missing, it is also possible to interpolate the missing data from data before and after it, thereby minimizing the effect of the missing slice.

It is a further intention of some embodiments of this invention to be able to shift the time reference with respect to the macro reference by adding or subtracting a time offset. This is done by shifting the association between the look up table time stamps the data they point to in the buffer. This comes in handy when one playback apparatus is a speaker at the far end of a room and a constant offset is helpful to phase the speaker output to the user listening preference.

It is also an object of some embodiments of this invention to be able to use any external signal 109 to provide macro timing instead of or in addition to signal 108. GPS systems use atomic clocks to synchronize their ranging satellite network. The signal from any one satellite may be used to synchronize the rendering network. Modern cellular systems also use GPS to generate clock signals that are transmitted to the cell phones. Therefore the cellular network may also be a source of an external macro timing signal 109.

Since it is possible in this embodiment, to have a multi-network bridging device, it is useful to also be able to take the macro synchronization clock from one network and transpose it into the appropriate format for any other network to which it might connect. This allows apparatus receiving the same content stream on different networks to also stay synchronized.

Although particular embodiments have been disclosed herein in detail, this has been done by way of example for purposes of illustration only, and is not intended to be limiting with respect to the scope of the appended claims, which follow. In particular, it is contemplated by the inventor that various substitutions, alterations, and modifications may be made without departing from the spirit and scope of the invention as defined by the claims. Other aspects, advantages, and modifications are considered to be within the scope of the following claims. The claims presented are representative of the inventions disclosed herein. Other, unclaimed inventions are also contemplated. The inventor reserves the right to pursue such inventions in later claims. For example, the inventor reserves the right to pursue the inventions described by the following numbered paragraphs 1-15.

1. A method for synchronizing content playback where
two or more content playback apparatus are
connected by a network to
one or more content sources, the
content being streams of digital multimedia data such as audio and video
and said content playback apparatus contains long data buffers and a look up table that is controlled by the rendering engine and/or the application program
whereby the content is rendered in such a way that the time difference between the rendering nodes of a stream is not distinguishable by human eye or ear.

2. A method in paragraph 1 where all apparatus are connected to the same power distribution network and use powerline communications as a means of communications and content distribution.

3. A method in paragraph 1 where the network may be but is not limited to DSL, Wi-Fi, cable and wired or wireless content distribution.

4. A method in paragraph 1 where the playback apparatus buffers the content prior to the playback and the depth of such buffers is controlled by the application program and may be changed remotely through the network and use powerline communications as the means of communication and content distribution.

5. A method in paragraph 4 where the buffered content is also equipped with timing data that is used to control the timing of the playback through the rendering engine.

6. A method in paragraph 5 where the timing data used to control and synchronize the rending engines of the rendering apparatuses is the time for the data to be rendered relative to a system-wide macro clock.

7. A method in paragraph 6 where the system-wide clock is driven by the special signal distributed through the same powerline network as the content.

8. A method in paragraphs 1 and 2 where the content rendering apparatus has the ability to add and remove time slices of the content in order to maintain the synchronization with the system-wide clock caused by the relative drift of the local clock.

9. A method in paragraph 8 where the addition of the content time slice is accomplished via replication of the previous slice.

10. A method in paragraph 8 where the addition of the content slice is accomplished via interpolation of the previous and the next slices.

11. A method in paragraph 1 where an additional time offset can be added to one or several of the playback apparatus.

12. A method in paragraph 1 where the apparatus are connected to different power networks and network-to-network signaling is used to synchronize each network against a macro time base.

13. A method in paragraph 1 where an external macro network synchronizations time reference is used.

14. A method in paragraph 13 where the external time reference is a GPS signal.

15. A method in paragraph 13 where the external time reference is a cellular signal.

What is claimed is:

1. A system for synchronizing content playback where
two or more content playback apparatus are
connected by a network to
one or more content sources, the
content being streams of digital multimedia data such as audio and video
and said content playback apparatus contains long data buffers and a look up table that is controlled by the rendering engine and/or the application program
whereby the content is rendered in such a way that the time difference between the rendering nodes of a stream is not distinguishable by human eye or ear.

2. A system in claim 1 where all apparatus are connected to the same power distribution network and use powerline communications as a means of communications and content distribution.

3. A system in claim 1 where the network may be but is not limited to DSL, Wi-Fi, Cable and wired or wireless content distribution.

4. A system in claim 1 where the playback apparatus has the ability to buffer the content prior to the playback and the depth of such buffers is controlled by the application program and could be changed remotely through the network and use powerline communications as the means of communication and content distribution.

5. A system in claim 4 where the buffered content is also equipped with the timing data that can be used to control the timing of the playback through the rendering engine.

6. A system in claim 5 where the timing data used to control and synchronize the rending engines of the rendering apparatuses is the time for the data to be rendered relative to a system-wide clock.

7. A system in claim 6 where the system-wide clock is driven by the special signal distributed through the same powerline network as the content.

8. A system in claim 1 where the content rendering apparatus has the ability to add and remove time slices of the content in order to maintain the synchronization with the system-wide clock caused by the relative drift of the local clock.

9. A system in claim 8 where the addition of the content time slice is accomplished via replication of the previous slice.

10. A system as in claim 2 where the content rendering apparatus has the ability to add and remove time slices of the content in order to maintain the synchronization with the system-wide clock caused by the relative drift of the local clock.

11. A system in claim 10 where the addition of the content time slice is accomplished via replication of the previous slice.

12. A system in claim 8 where the addition of the content slice is accomplished via interpolation of the previous and the next slices.

13. A system in claim 1 where an additional time offset can be added to or subtracted from one or several of the playback apparatus.

14. A system in claim 1 where the apparatus are connected to different power networks and network-to-network signaling is used to synchronize each network against a macro time base.

15. A system in claim 14 where an external macro network synchronizations time reference is used.

16. A system in claim 15 where the external time reference is a GPS signal.

17. A system in claim 15 where the external time reference is a cellular signal.
